(19) United States
(12) Patent Application Publication
(10) Pub. No.: US 2016/0217444 A1
(43) Pub. Date: Jul. 28, 2016

(54) AUTOMATED PAYMENT COLLECTION SYSTEM AND METHOD

(71) Applicant: Kelly G. Martin, Woodstock, GA (US)

(72) Inventor: Kelly G. Martin, Woodstock, GA (US)

(21) Appl. No.: 14/604,300

(22) Filed: Jan. 23, 2015

(51) Int. Cl. G06Q 20/14; G06Q 40/00; G06Q 20/18

(52) U.S. Cl. CPC G06Q 20/14; G06Q 20/18; G06Q 40/10

(57) ABSTRACT

An automated system for electronic payment to one or more departments or agencies within a city, township, county, local or state government. The system has a plurality of separate agency or department databases and an icon or module menu of each department at a payment kiosk or payment computer connected to each database. Activating the icon or selecting the module directs a payor to the desired agency or department database. Inputting the payor information into the kiosk or payment computer generates an invoice to be paid. An integrated system provides the payor requested invoice of a bill, fee, tax or fine for that department or agency and simultaneously checks the payor information against each other database for any outstanding bills, fees, taxes or fines and generates a list of said outstanding bills, fees, taxes or fines.

### TECHNICAL FIELD

The present invention relates to a system and associated method of coordinating a systematic payment system for municipalities, counties, state and or federal governments wherein a user activated payment initiates and creates an automatic check of outstanding invoices, fines and fees owed or a manual input by staff initiates the check off.

### BACKGROUND OF THE INVENTION

The current operation of local, city, county or state agencies is one of a large collection of departments and offices that provide various governmental services to the public. Each of these departments can and does charge fees, collect taxes or create invoices, fines and fees for users for the services provided. Each department or agency provides its own collection and processing of payments or contracts this to outside vendors.

The funding of the activities within these governmental entities relies heavily on the tax revenues generated and collected and the payments of fees, fines and invoices to the various agencies. Accordingly, the budgeting and funding relies on an efficient collection system.

Unfortunately, the fact that these municipal enterprises are so diverse and disparate and compartmentalized and the range of activities so broad, there is no effective way to coordinate all the various activities in such a way that one agency understands or has access to the others databases and as a practical matter, some agencies are so specialized that standardizing the computer database may in fact degrade some agencies compatibilities.

Typically, the training and systems in place at one agency may not be comparable to another, nevertheless, many software firms attempting to modernize interdepartmental interfaces by requesting or worse requiring scrapping entire systems in an individual agency to allow adoption of more generic programming that actually is more cumbersome and less customizable for a particular department or agency.

The fact is the “sunk cost” already in these custom fitted systems within a department can be in the millions of dollars. Scrapping them only increases the front end cost of modernizing. This prevents any improvement progress. What is needed is a way to coordinate collections without interfering with the existing systems.

The present invention provides a payments collection solution without changing or degrading the agencies or departments current systems. This allows an implementation with no cost for replacing existing programs and methods as is currently required by others in this field. The present invention provides a cross check of all connected agencies and departments providing automatic debt retrieval from each agency at the time of a single user transaction or staff input.

### SUMMARY OF THE INVENTION

An automated system for electronic payment to one or more departments or agencies within a city, township, county, local or state government. The system has a plurality of separate agency or department databases and an icon or module menu of each department at a payment kiosk or payment computer connected to each database. Activating the icon or selecting the module directs a payor to the desired agency or department database. Inputting the payor information into the kiosk or payment computer generates an invoice to be paid. An integrated system provides the payor requested invoice of a bill, fee, tax or fine for that department or agency and simultaneously checks the payor information against each other database for any outstanding bills, fees, taxes or fines and generates a list of said outstanding bills, fees, taxes or fines.

The payor can select to pay one or more of the outstanding bills or can pay all the outstanding bills. Similarly, the agency can collect only the invoice generated or can collect one or more of said outstanding bills.

Optionally, the outstanding bills can be sent as liens against state income tax refunds per House Bill 1000 for immediate collection.

A method for a payor to make an electronic payment to one or more departments or agencies within a city, township, county or local or state government has the steps of coming to a local government agency or department payment site, computer or kiosk; selecting the department or agency where the transaction is to be made; entering the information needed to perform the transaction including payor information identifying the payor; providing an integrated system connected to other department or agency databases within said local government and cross checking each connected database for outstanding invoices, bills, fines, fees payments or taxes; generating an invoice or list of payor debts owed; and paying said debts.

The method of payment further may include the step of placing a lien on withheld income taxes as a source of invoice payment.

### BRIEF DESCRIPTION OF THE DRAWINGS

The invention will be described by way of example and with reference to the accompanying drawings in which:

FIG. 1 is a diagrammatic view of a user payment interface of the present invention.

FIG. 2 is a similar view to FIG. 1 showing the user payment interface.

FIG. 3 is a schematic flow chart of the method of using the present invention.

### DETAILED DESCRIPTION OF THE INVENTION

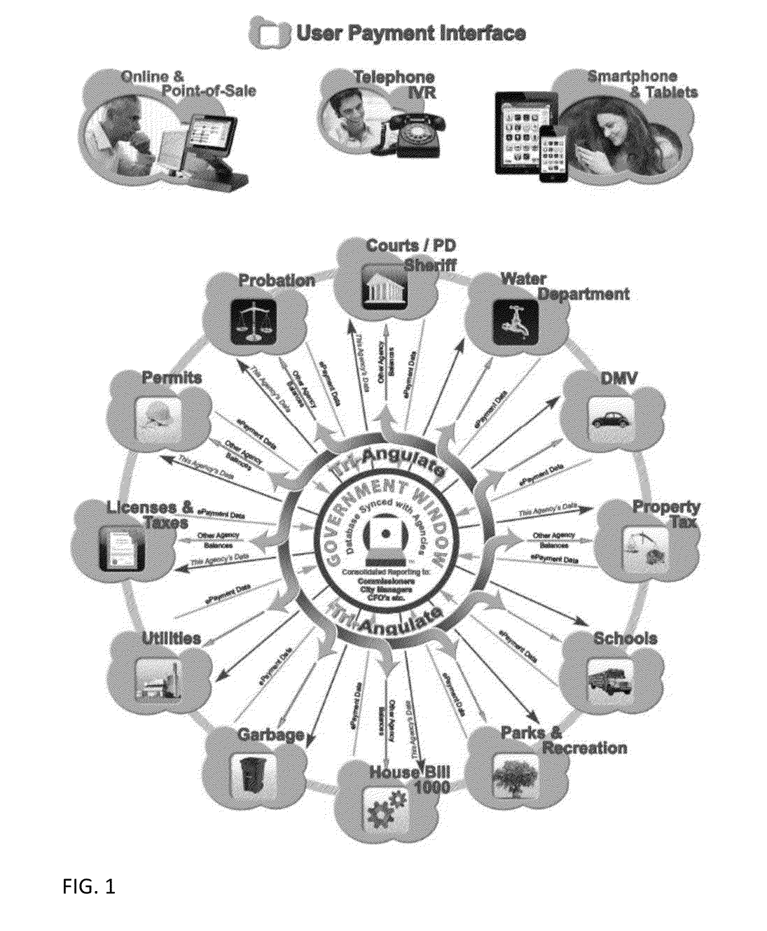

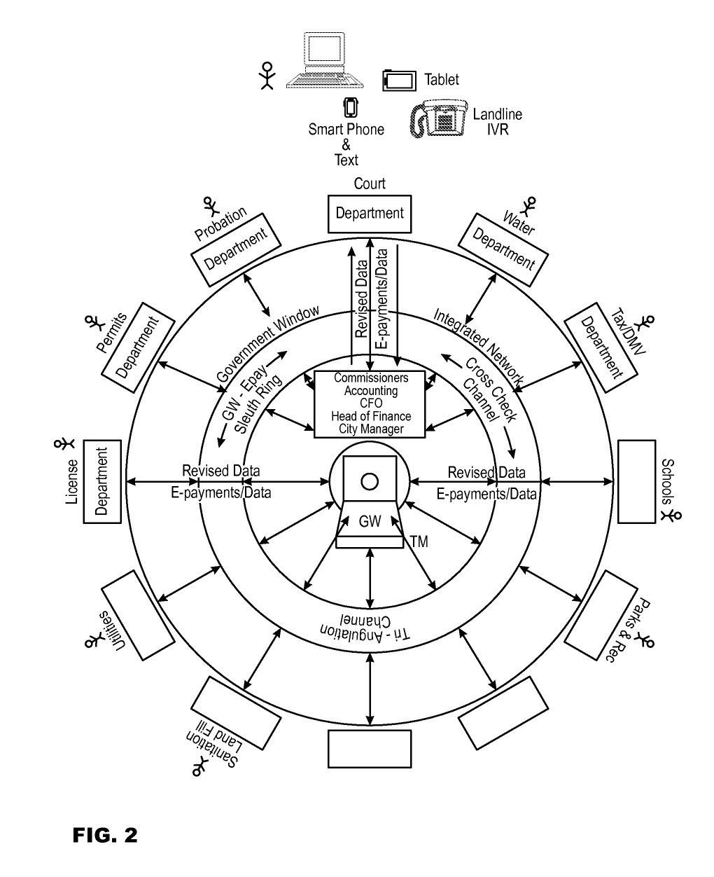

With reference to FIGS. 1 and 2, a schematic diagram is shown showing the user payment interface. As shown, the top icons show an online point of sale capability or an optional telephone interactive voice response (IVR) payment capability or an add-on application that can be provided on a smart phone or tablet allowing the user to make payments as needed. These capabilities can be provided for electronic payment of any debt to a local government agency, local municipalities such as cities, townships or counties have numerous agencies which generate bills or invoices such as fines, taxes, penalties, child support or the like. These must be paid by the citizen charged with such payments. An important aspect of the present invention is that it provides each agency a unique way of making a collection from a user in such a fashion that not only will its bill be paid, but it alerts the user and the agency of other outstanding bills in the related agencies in the jurisdiction whether it be a county, city, state or township. This allows the user of the system to take separate databases that can be totally independent otherwise and have them connected on an electronic payment system that provides an interactive system that upon the initiation of user input such as identifying indications such as name, address, social security number or driver license will provide sufficient information for the system to cross check that information against every database connected to the system.

As shown in FIG. 1, the individual departments are illustrated around the outer perimeter. These can include the probation department, the courts, the police or sheriff department, the water department, department of motor vehicles (DMV), property tax, schools, parks and recreation, garbage, utilities, license and taxes, and permits. These different agencies are unique and distinct and have their own computer software generally. An important aspect of the present invention is that these systems need not be altered in any fashion. A simple edition shown in a center ring is a connecting area shown best in FIG. 2 as a cross check channel. It is an integrated network. This integrated network often called Government Window by the inventors provides a means for connecting each department that is independently and otherwise very diverse in either their software programming or their systems to be connected for bill collection and payment. This center ring, if you will, creates a sleuth ring identified as a sleuth because it enables the user input to quietly and conveniently be cross checked at the various departments. For example, a person expecting a building permit goes to the building permit department and finds that he would have an invoice for permit of approximately $200.00; however, as the system is inputted with the payor information, it notes that this person also has additional 10 or 20 invoices for unpaid parking fines. At this point the agency can make a determination whether to allow the person to get the permit or whether or not they also want to collect on the outstanding parking fines. At this point a decision needs to be made. The agency can, at its discretion, can collect the fee that it otherwise would have or preferably collect all the fees that are due to the government agency. These fees may seem minor, however, when thousands of citizens have unpaid bills that are due and collectible, it can add up to be in the millions of dollars. This makes a difference in whether property taxes need to be raised or department funding has to be cut. By getting proper collections in, these outstanding bills can be quickly and promptly processed using this system.

Additionally, a new bill passed recently called House Bill 1000 (HB 1000) permits liens to be placed on any outstanding county or state or local government bill. Such a lien would be applied against a person's income taxes being withheld. When this lien is placed, the payments can be made directly to the agency. This helps insure that state tax refunds aren't paid to citizens who have outstanding municipal, city, county or state bills. This creates a vast advantage over prior systems that in the past, in order to accomplish this, all of the software in each department must be able to communicate with the others. This created an undue burden that made it almost impossible for agencies to work together in a systematic way to achieve a sufficient collection retrieval system. The present invention provides a way of doing this.

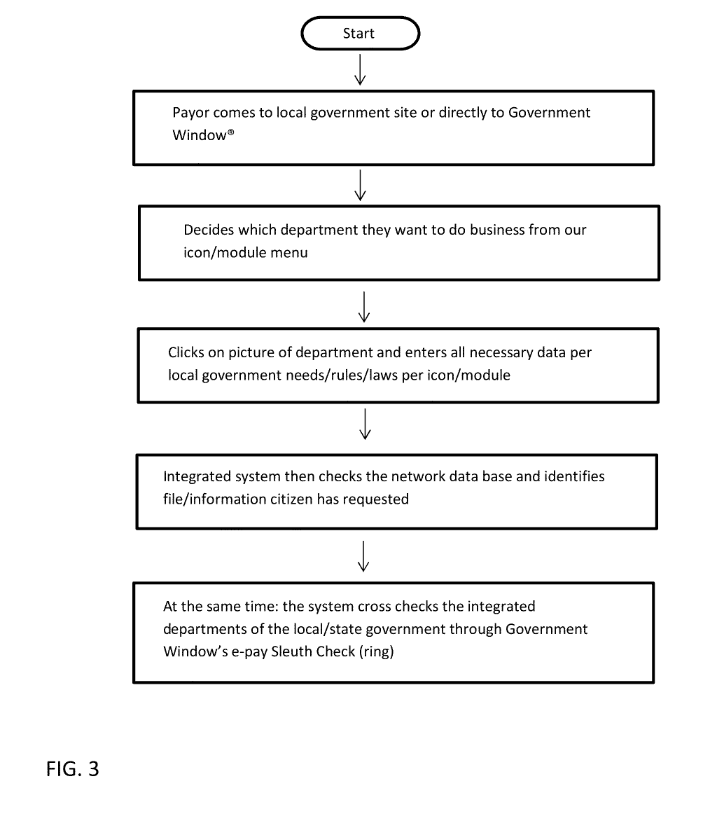

As shown in FIG. 3, a payor will come to a local government site or directly to Government Window® payment kiosk, which could be on a tablet or a phone, and decide which department they want to do business with by selecting an icon or module on a menu. They click on a picture of a government department and the user enters any necessary data for the local needs, rules or laws per icon module. The integrated system will then check the network database and identify file or information the citizen has requested. While doing this, at the same time, the system cross checks by being connected to all the other agencies in the inner ring called the sleuth ring and triangulates this information in such a fashion that any outstanding bills will be triggered and a list of these bills will be identified and the user will be notified of the awareness of the agency or department of all these outstanding bills. The sleuth check ring is an ideal way of giving information to the users of the system of any outstanding bills they may need to pay. If the user opts not to pay all the bills, that is at the discretion of the department if they will process the requested transaction. If they choose not to, then the user will not receive the necessary transaction that he asked for, or alternatively, he will have to pay one or more of the outstanding bills. If the user refuses to pay, the state has the option of providing a lien against all these payments. When such a lien is made, this will go against the withholding income taxes of the individual within that state or jurisdiction.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described, which will be within the full intended scope of the invention as defined by the following appended claims.

What is claimed is:

1. An automated system for electronic payment to one or more departments or agencies within a city, township, county, local or state government comprises:
a plurality of separate agency or department databases;
an icon or module menu of each department at a payment kiosk or payment computer connected to each database, wherein activating the icon or selecting the module directs a payor to the desired agency or department database, and inputting the payor information into the kiosk or payment computer generates an invoice to be paid;
an integrated system provides the payor requested invoice by a bill, fee, tax or fine for that department or agency and simultaneously checks the payor information against each other database for any outstanding bills, fees, taxes or fines; and
generating a list of said outstanding bills, fees, taxes or fines.

2. The automated system of claim 1 wherein the payor can select to pay one or more of the outstanding bills.

3. The automated system of claim 1 wherein the payor can pay all the outstanding bills.

4. The automated system of claim 1 wherein the agency can collect only the invoice generated.

5. The automated system of claim 1 wherein the agency can collect one or more of said outstanding bills.

6. The automated system of claim 1 wherein the outstanding bills are sent as liens against income tax refunds per House Bill 1000 for immediate collection.

7. A method for a payor to make an electronic payment to one or more departments or agencies within a city, township, county or local or state government comprises the steps of:
coming to a local government agency or department payment site, computer or kiosk;
selecting the department or agency where the transaction is to be made;
entering the information needed to perform the transaction including payor information identifying the payor;
providing an integrated system connected to other department or agency databases within said local government and cross checking each connected database for outstanding invoices, bills, fines, fees payments or taxes;
generating an invoice or list of payor debts owed; and
paying said debts.

8. The method of claim 7 wherein the method of payment further comprises the step of:
placing a lien on withheld income taxes as a source of invoice payment.
